(19) United States
(12) Patent Application Publication
(10) Pub. No.: US 2023/0403700 A1
(43) Pub. Date: Dec. 14, 2023

(54) Method for Beam Mapping

(71) Applicant: Nokia Technologies Oy, Espoo (FI)

(72) Inventors: Matha Deghel, Paris (FR); Keeth Saliya LADDU JAYASINGHE, Espoo (FI)

(21) Appl. No.: 18/033,128

(22) PCT Filed: Oct. 22, 2020
(86) PCT No.: PCT/EP2020/079788

§ 371 Date: Apr. 21, 2023

(51) Int. Cl. H04W 72/1268; H04W 72/0446

(52) U.S. Cl. CPC H04W 72/1268; H04W 72/0446

(57) ABSTRACT

An apparatus including: circuitry for obtaining a first configuration from a network element, the first configuration including multiple beam mapping patterns for mapping at least two beams to at least two Physical Uplink Shared Channel (PUSCH) repetitions, wherein the beam mapping patterns are associated with at least one time domain resource assignment option; circuitry for obtaining an indication of a time domain resource assignment for PUSCH repetition operation from the network element; circuitry for checking whether beam mapping patterns are associated with the indicated time domain resource assignment; circuitry responsive to only one beam mapping pattern associated with the indicated time domain resource assignment, for using said one beam mapping pattern for mapping at least two PUSCH repetitions; and circuitry responsive to multiple beam mapping patterns associated with the indicated time domain resource assignment, for selecting one beam mapping pattern according to predefined criteria.

### TECHNICAL FIELD

The present invention relates to beam mapping patterns.

### BACKGROUND

One of the new service categories introduced in 5G NR networks is ultra-reliable low-latency communication (URLLC). The two latest versions of the 5G standard, 3GPP Release 15 and 16, have built the physical implementation of URLLC to meet the two conflicting requirements of reliability and latency.

3GPP Release 15 introduced a slot-based transmission of OFDM symbols of a packet for Physical Uplink Shared Channels (PUSCH) referred to as repetition Type A, where PUSCH repetition via slot aggregation was supported in a semi-static way, i.e. no repetition within a slot. Therein, to avoid transmitting a long PUSCH across slot boundary, the user equipment (UE) may transmit (small) PUSCHs in several repetitions in the consecutive available slots. For further reducing latency, 3GPP Release 16 introduced PUSCH repetition Type B, where a transport block is scheduled allowing cross-slot-boundary and cross-DL-symbols repetitions.

One important aspect of 5G NR networks is the multi-transmission/reception points (multi-TRP) features, which relate to communication via multiple radio beams between access point and UEs provided with multiple input-multiple output (MIMO) antennas, i.e. antenna array consisting of a large amount of antenna elements, implemented in a single antenna panel or in a plurality of antenna panels, and capable of using a plurality of simultaneous radio beams for communication.

However, the PUSCH repetition type B is still completely silent about how to implement the PUSCH repetition transmission in multi-TRP and/or multi-panel transmission. Hence, the multi-TRP deployment may relate to a situation, where PUSCH repetitions may be performed towards different TRPs, where for example two UL beams are used for the group of PUSCH repetitions. For example, the beam switching latency aspects are not considered at all.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for obtaining a first configuration from a network element, the first configuration comprising multiple beam mapping patterns for mapping at least two beams to at least two Physical Uplink Shared Channel (PUSCH) repetitions, wherein one or more beam mapping patterns are associated with at least one time domain resource assignment option; means for obtaining an indication of a time domain resource assignment for PUSCH repetition operation from the network element; means for checking whether one or more beam mapping patterns are associated with the indicated time domain resource assignment; means, responsive to only one beam mapping pattern being associated with the indicated time domain resource assignment, for using said one beam mapping pattern for mapping said at least two PUSCH repetitions; and means, responsive to multiple beam mapping patterns being associated with the indicated time domain resource assignment, for selecting one beam mapping pattern for mapping said at least two PUSCH repetitions according to predefined criteria.

According to an embodiment, the one or more beam mapping patterns are associated as common for all of said time domain resource assignment options.

According to an embodiment, a different set of one or more beam mapping patterns is associated with each of said time domain resource assignment options.

According to an embodiment, said one or more beam mapping patterns are configured according to one or more of the following parameters:
type of the mapping pattern, such as sequential mapping, cyclical mapping, half-to-half mapping, or any other type of pattern;
basis for mapping, such as mapping performed on nominal PUSCH repetitions, actual PUSCH repetitions, on at least one symbol basis and/or on a slot-basis.

According to an embodiment, said predefined criteria is stored in a memory of the apparatus.

According to an embodiment, the apparatus comprises

means for obtaining a second configuration from the network element, the second configuration comprising said predefined criteria for selecting among the multiple beam mapping patterns associated with the indicated time domain resource assignment.

According to an embodiment, said means for selecting one beam mapping pattern is configured to select the type of the mapping pattern that minimizes the number of symbols that need to be muted accounting for at least one beam switching delay.

According to an embodiment, said means for selecting one beam mapping pattern is configured to select the type of the mapping pattern that maximizes the number of beam switching instances.

According to an embodiment, said means for selecting one beam mapping pattern is configured to select the type of the mapping pattern that minimizes the number of repetitions towards at least one transmission/reception point (TRP).

According to an embodiment, said means for selecting one beam mapping

pattern is configured to use the starting redundancy version (RV) indication per TRP to determine the type of the mapping pattern.

According to an embodiment, said means for selecting one beam mapping pattern is configured to select a default type of the mapping pattern among a plurality of patterns satisfying the predefined criteria,

According to an embodiment, the apparatus comprises means for obtaining an indication from the network element to activate or deactivate the mapping of the at least two beams for PUSCH repetition operation.

According to an embodiment, the apparatus comprises means for obtaining an indication from the network element to use a specific beam mapping pattern.

An apparatus according to a second aspect comprises at least one processor and at least one memory, said at least one memory stored with computer program code thereon, the at least one memory and the computer program code configured to, with the at least one processor, cause the apparatus at least to perform: obtain a first configuration from a network element, the first configuration comprising multiple beam mapping patterns for mapping at least two beams to at least two Physical Uplink Shared Channel (PUSCH) repetitions, wherein one or more beam mapping patterns are associated with at least one time domain resource assignment option; obtain an indication of a time domain resource assignment for PUSCH repetition operation from the network element; check whether one or more beam mapping patterns are associated with the indicated time domain resource assignment; and if only one beam mapping pattern is associated with the indicated time domain resource assignment, use said one beam mapping pattern for mapping said at least two PUSCH repetitions; or else select, from the multiple beam mapping patterns associated with the indicated time domain resource assignment, one beam mapping pattern for mapping said at least two PUSCH repetitions according to predefined criteria.

A method according to a third aspect comprises obtaining, by the user equipment, a first configuration from a network element, the first configuration comprising multiple beam mapping patterns for mapping at least two beams to at least two Physical Uplink Shared Channel (PUSCH) repetitions, wherein one or more beam mapping patterns are associated with at least one time domain resource assignment option; obtaining an indication of a time domain resource assignment for PUSCH repetition operation from the network element; checking whether one or more beam mapping patterns are associated with the indicated time domain resource assignment; and if only one beam mapping pattern is associated with the indicated time domain resource assignment, using said one beam mapping pattern for mapping said at least two PUSCH repetitions; or else selecting, from the multiple beam mapping patterns associated with the indicated time domain resource assignment, one beam mapping pattern for mapping said at least two PUSCH repetitions on according to predefined criteria.

An apparatus according to a fourth aspect comprises means for providing a user equipment with a first configuration comprising multiple beam mapping patterns for mapping at least two beams to at least two PUSCH repetitions, wherein one or more beam mapping patterns are associated with at least one time domain resource assignment option; and means for providing the user equipment with an indication of a time domain resource assignment for allocating network resources for a PUSCH repetition operation.

According to an embodiment, the apparatus comprises means for providing the user equipment with a second configuration comprising predefined criteria for selecting among the multiple beam mapping patterns associated with the indicated time domain resource assignment.

An apparatus according to a fifth aspect comprises at least one processor and at least one memory, said at least one memory stored with computer program code thereon, the at least one memory and the computer program code configured to, with the at least one processor, cause the apparatus at least to perform: provide a user equipment with a first configuration comprising multiple beam mapping patterns for mapping at least two beams to at least two PUSCH repetitions, wherein one or more beam mapping patterns are associated with at least one time domain resource assignment option; and provide the user equipment with an indication of a time domain resource assignment for allocating network resources for a PUSCH repetition operation.

A method according to a sixth aspect comprises: providing a user equipment with a first configuration comprising multiple beam mapping patterns for mapping at least two beams to at least two PUSCH repetitions, wherein one or more beam mapping patterns are associated with at least one time domain resource assignment option; and providing the user equipment with an indication of a time domain resource assignment for allocating network resources for a PUSCH repetition operation.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating a dual-SIM/MUSIM arrangement according to the embodiments;

FIG. 2 shows schematically a layout of an apparatus according to an example embodiment;

FIG. 3 shows a part of an exemplifying radio access network;

FIGS. 4a and 4b show examples of segmentation of nominal repetitions in PUSCH Repetition Type B;

FIG. 5 shows a flow chart for a beam mapping procedure in a user equipment according to an embodiment;

FIG. 6 shows a signalling chart for a beam mapping procedure according to an embodiment;

FIGS. 7a-7c show examples of beam mapping operations in case of PUSCH Repetition Type B according to various embodiments;

FIG. 8 shows a flow chart for a beam mapping procedure in a network element according to an embodiment.

### DETAILED DESCRIPTION OF SOME EXAMPLE EMBODIMENTS

The following describes in further detail suitable apparatus and possible mechanisms carrying out the beam mapping operations. While the following focuses on 5G networks, the embodiments as described further below are by no means limited to be implemented in said networks only, but they are applicable in any network supporting beam mapping operations.

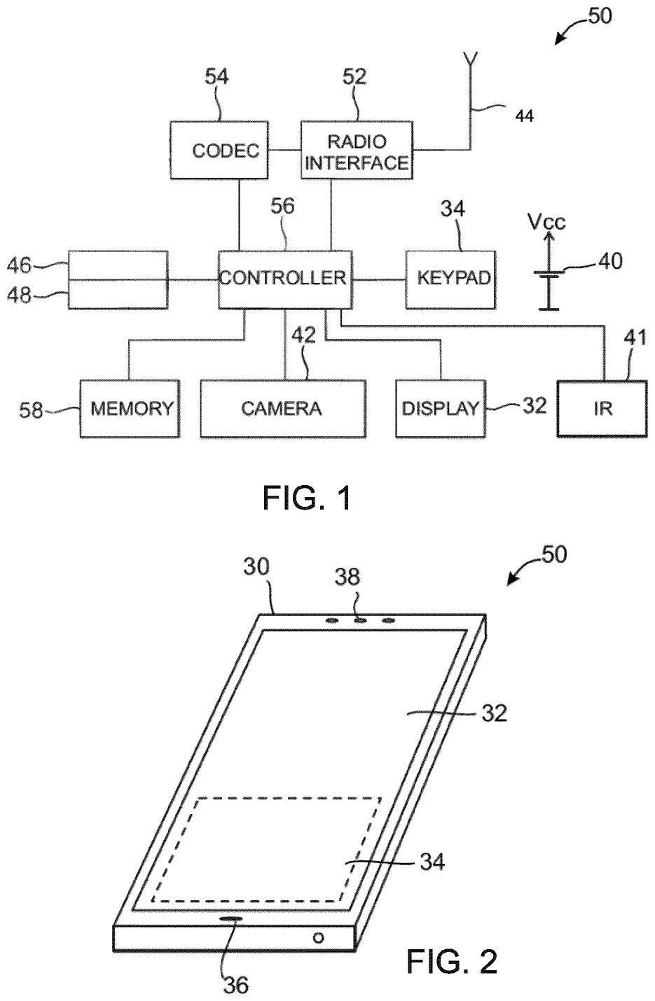

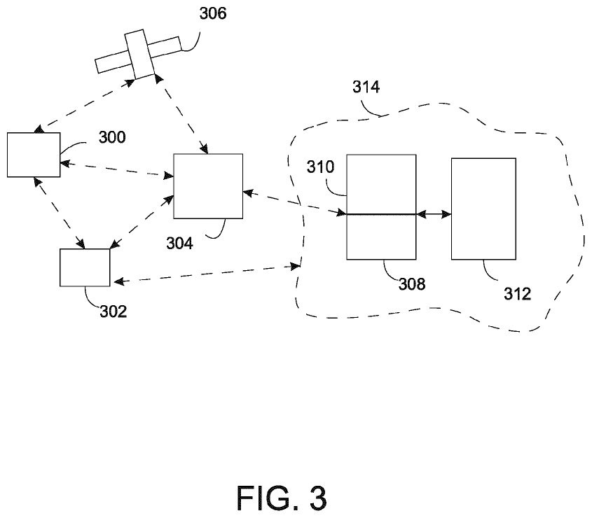

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UNITS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

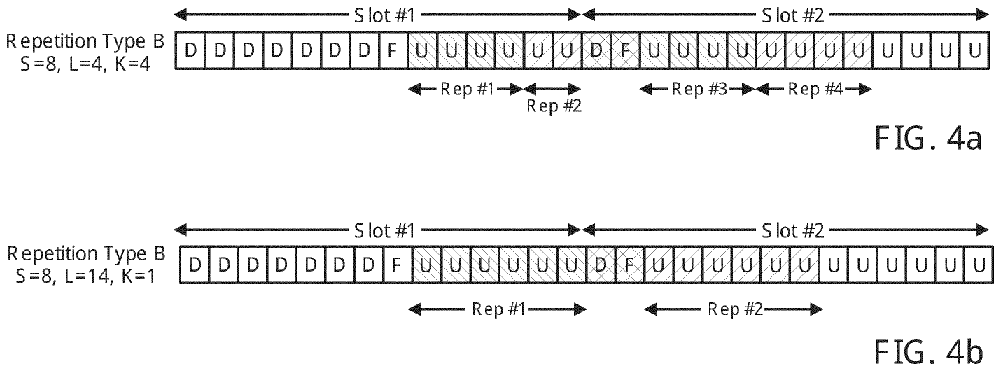

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g)NodeB) 304 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in L′I′E networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)NodeBs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states is controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

For the 5G technology, one of the most important design goals has been improved metrics of reliability and latency, in addition to network resilience and flexibility. To meet the requirements of emerging applications such as intelligent transportation, augmented virtual reality, industrial automation, etc, three new service categories has been defined for 5G: enhanced mobile broadband (eMBB), massive machine-type communication (mMTC) and ultra-reliable low-latency communication (URLLC).

The two latest versions of the 5G standard, 3GPP Release 15 and 16, have built the physical implementation of URLLC to meet the two conflicting requirements of reliability and latency. The implementation includes e.g. higher subcarrier spacings and thus shorter OFDM symbol lengths (a.k.a. numerology), sub-slot transmission time intervals, and configured grant resources.

3GPP Release 15 introduced a slot-based transmission of OFDM symbols of a packet for PUSCH referred to as repetition Type A, where PUSCH repetition via slot aggregation was supported in a semi-static way, i.e. no repetition within a slot, with aggregation factor of 2, 4 or 8. Therefore, to avoid transmitting a long PUSCH across slot boundary, the UE may transmit (small) PUSCHs in several repetitions scheduled by an uplink grant procedure or RRC in the consecutive available slots. For reducing latency, 3GPP Release 16 introduced PUSCH repetition Type B, where a transport block is scheduled allowing cross-slot-boundary and cross-DL-symbols repetitions.

PUSCH transmission resources for uplink (UL) may be configured to the UE by the gNB as configured grant (CG) transmission resources. The UE uses these CG resources to transmit data on PUSCH directly to the gNB without transmitting scheduling request (SR) and receiving UL grant as dynamic grant (DG) transmission. 3GPP Release 16 introduced PUSCH repetition Type B for both DG-based PUSCH and CG-based PUSCH, wherein for a transport block, one dynamic UL grant or one configured grant schedules two or more PUSCH repetitions that can be in one slot, or across slot boundary in consecutive available slots.

For PUSCH repetition Type B, time domain resource assignment (TDRA) field in downlink control information (DCI) may be used as a basis for deriving the resources for the first “nominal” repetition. The time domain resources for the remaining repetitions are derived based at least on the resources for the first repetition and UL/DL direction of symbols. The time resource allocation is defined by S (starting symbol), L (length of each nominal repetition) and K (number of nominal repetitions), which are signalled as part of the TDRA entry. TDRA field in DCI indicates one of the entries in the TDRA table. The PUSCH transmission occurs within the time window of L*K symbols, starting from the indicated starting symbol.

One “nominal” repetition can be segmented into one or more “actual” repetitions around semi-static DL symbols and dynamically indicated/semi-statically configured invalid UL symbols and/or at the slot boundary.

For dynamic grant, the actual repetitions are transmitted. There should not be conflict between the transmitted symbols and the dynamic DL/flexible symbols indicated by a dynamic slot format indicator (SFI).

For configured grant, whether the actual repetition is transmitted or not follows the principle of 3GPP Release 15: the actual repetition is not transmitted, if it conflicts with any dynamic DL/flexible symbols; if it conflicts with any semi-static flexible symbol; or if a dynamic SFI is configured but not received.

The RRC parameter InvalidSymbolPattern defines an invalid symbol pattern for PUSCH repetition Type B and it is mainly used to avoid certain PUCCH/SRS at the end of the slot and DL/UL switching gap.

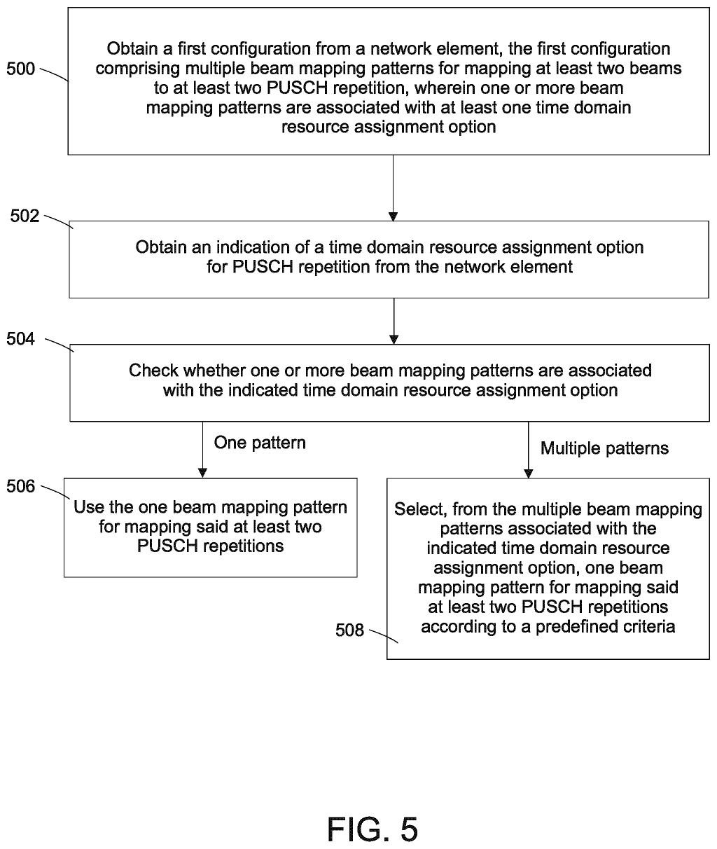

FIGS. 4a and 4b show some examples of segmentation of nominal repetitions in PUSCH Repetition Type B into actual repetitions. In FIG. 4a, the information obtained from the respective TDRA entry indicates that the starting symbol of the PUSCH repetition S=8 (the first OFDM symbol of the slot assigned as 0), the length of each nominal repetition L=4 and the number of the nominal repetitions K=4. This is segmented into four actual repetitions: the first repetition Rep #1 includes the symbols 8-11 of the first slot and the second repetition Rep #2 includes the last symbols 12 and 13 of the first slot. At the slot boundary, there is a DL/UL switching gap for the duration of the symbols 0 and 1 of the second slot. Consequently, the third repetition Rep #3 starts at the symbol 2 and includes the symbols 2-5 of the second slot and the fourth repetition Rep #4 includes the symbols 6-9 of the second slot.

In FIG. 4b, the information obtained from the respective TDRA entry indicates that the starting symbol of the PUSCH repetition S=8, the length of each nominal repetition L=14 and the number of the nominal repetitions K=1. Thus, there is only one nominal repetition, but it extends over two slots. This is segmented into two actual repetitions: the first repetition Rep #1 includes the symbols 8-13 of the first slot. At the slot boundary, there is again a DL/UL switching gap for the duration of the symbols 0 and 1 of the second slot. Consequently, the second repetition Rep #2 starts at the symbol 2 and includes the symbols 2-7 of the second slot.

Thus, it can be concluded that in comparison to PUSCH repetition type A, the cross-slot-boundary and cross-DL-symbol allocation of PUSCH repetition type B reduces the latency without sacrificing the reliability of transmission. However, the PUSCH repetition type B is still completely silent about how to implement the PUSCH repetition transmission in multi-TRP and/or multi-panel transmission. Hence, the multi-TRP deployment may relate to a situation, where PUSCH repetitions may be performed towards different TRPs, where for example two UL beams are used for the group of PUSCH repetitions.

Therein, beam switching latency aspects, inter alia, need to be considered, whereupon at least two specific cases arise: a) UL beam switching does not require switching to/activating a different panel of the UE antenna, i.e. the UL beams are from the same panel, and b) UL beam switching requires switching to/activating a different panel of the UE antenna. It is noted that the beam switching latency may be different for the two cases above.

In the following, an enhanced method for beam mapping for PUSCH repetitions will be described in more detail, in accordance with various embodiments.

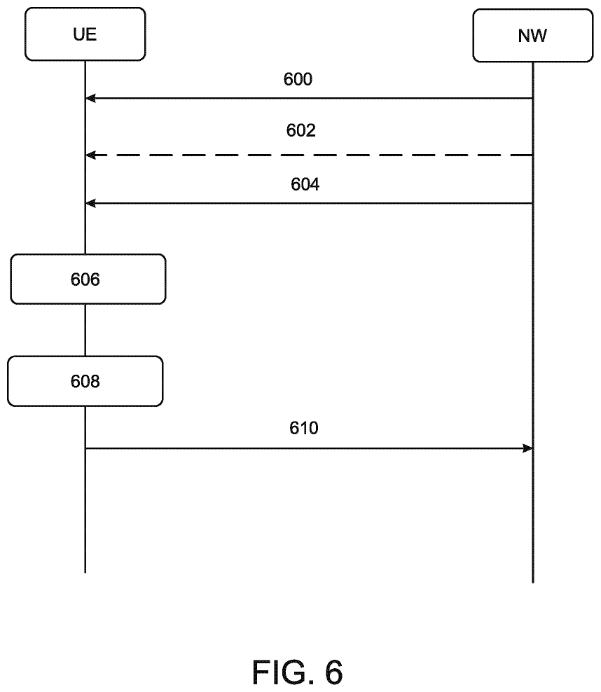

The method, which is disclosed in flow chart of FIG. 5 as reflecting the operation of a terminal apparatus, such as a user equipment (UE), wherein the method comprises obtaining (500), by the user equipment, a first configuration from a network element, the first configuration comprising multiple beam mapping patterns for mapping at least two beams to at least two PUSCH repetitions, wherein one or more beam mapping patterns are associated with a time domain resource assignment option; obtaining (502) an indication of a time domain resource assignment for PUSCH repetition operation from the network element; checking (504) whether one or more beam mapping patterns are associated with the indicated time domain resource assignment; and if only one beam mapping pattern is associated with the indicated time domain resource assignment, using (506) said one beam mapping pattern for mapping said at least two PUSCH repetitions; or else selecting (508), from the multiple beam mapping patterns associated with the indicated time domain resource assignment, one beam mapping pattern for mapping said at least two PUSCH repetitions according to predefined criteria.

Thus, the method enables to efficiently map the indicated and/or configured UL beams to PUSCH repetitions, where the beam mapping pattern is selected in such a way to satisfy certain predefined or configured criteria and taking into account the PUSCH allocation. The network configures the UE with multiple beam mapping patterns that allow the UE to map at least two beams to the applicable PUSCH allocation.

It is noted that while the embodiments as described herein focus on mapping the multiple PUSCH repetitions on at least two UL beams, such as in a situation of multi-TRP and/or multi-panel transmission, the first configuration may as well comprise beam mapping pattern for mapping said at least two PUSCH repetitions on one UL beam, such as described above for PUSCH repetition Types A or B. Thus, the embodiments as described herein may be considered an enhancement for indicating the mapping of the multiple PUSCH repetitions on one or more UL beams.

It is further noted that herein the terms UL beam, UL TCI (Transmission configuration indicator) state, spatial relation, SRI (SRS resource indicator), and UL transmit spatial filter refer to the same thing and can be used interchangeably.

In the configuration, one or more beam mapping patterns are associated with at least one time domain resource assignment option, and the applicable beam mapping pattern is selected based on a time domain resource assignment indicated by the network. The time domain resource assignment option may refer, for example, to an entry of a TDRA table, whereupon the network may indicate the TDRA entry, for example via the RRC or a MAC control element, as a basis for checking the associated beam mapping patterns. Alternatively, the TDRA parameters may be provided in type 1 of configured grant (CG), where radio resource control (RRC) signalling configures the time domain resource allocation including periodicity of CG resources, offset, start symbol and length of PUSCH as well as the number of repetitions. Yet alternatively, the UE may be configured, for example via the RRC or the MAC control element, with more than one beam mapping pattern without any association to the TDRA entries.

If only one beam mapping pattern is associated with the indicated time domain resource assignment, the UE uses said beam mapping pattern for mapping the PUSCH allocation on at least two beams. However, if there are multiple beam mapping patterns associated with the indicated time domain resource assignment, the UE selects the applicable beam mapping pattern based on predefined criteria.

According to an embodiment, said one or more beam mapping patterns are configured according to one or more of the following parameters:
type of the mapping pattern, such as sequential mapping, cyclical mapping, half-to-half mapping, or any other type of pattern;
basis for mapping, such as mapping performed on nominal PUSCH repetitions, actual PUSCH repetitions, on at least one symbol basis and/or on a slot-basis.

Thus, the UE is provided with the parameters needed to configure the beam mapping pattern, and after determining the applicable beam mapping pattern, either as the single option or based on the predefined criteria, the UE adjusts the parameters accordingly. Herein, sequential mapping may refer to a pattern, where the first beam is applied to the first and second PUSCH repetitions, and the second beam is applied to the third and fourth PUSCH repetitions, and the same beam mapping pattern continues to the remaining PUSCH repetitions. Cyclical mapping may refer to a pattern, where the first and second beam are applied to the first and second PUSCH repetition, respectively, and the same beam mapping pattern continues to the remaining PUSCH repetitions. Half-to-Half mapping may refer to a pattern, where the first beam is applied to the first half of PUSCH repetitions, and the second beam is applied to the second half of PUSCH repetitions. At least one symbol basis mapping may refer to a mapping performed on a group of symbols. Slot-basis mapping may refer to mapping beams to different slots, but not in the granularity of actual/nominal repetition.

According to an embodiment, said predefined criteria is stored in a memory of the user equipment.

According to an embodiment, the method comprises obtaining, by the user equipment, a second configuration from the network element, the second configuration comprising said predefined criteria for selecting among the multiple beam mapping patterns associated with the indicated time domain resource assignment.

Thus, the predefined criteria may be previously stored in the UE, or the network may provide the UE with the criteria, for example, on the basis of changing operating conditions of the network. It is noted that the network may send the first configuration and the second configuration in a common or in separate transmissions. The criteria may comprise various conditions and/or rules, according to which the beam mapping pattern is selected.

According to an embodiment, the UE may be configured to select the type of the mapping pattern that minimizes the number of symbols that need to be muted accounting for beam switching delay(s). Herein, the sequential mapping, for example, may provide the minimum number of symbols to be muted.

According to an embodiment, the UE may be configured to select the type of the mapping pattern that maximizes the number of beam switching instances. Herein, the aim may relate to maximizing the diversity in time, which may be achieved, for example, by the cyclic mapping.

According to an embodiment, the UE may be configured to select the type of the mapping pattern that minimizes the number of repetitions towards at least one TRP. Herein, the aim is to minimize the number of PUSCH repetition transmissions towards one or more, even each, TRP.

According to an embodiment, the UE may use the starting redundancy version (RV) indication per TRP to determine the type of the mapping pattern. Here, it is possible that the starting RV for each TRP to be configured differently via RRC, and the selection rule may have some association to the starting RV configuration.

According to an embodiment, the UE may be configured to select a default type of the mapping pattern among a plurality of patterns satisfying the predefined criteria. Thus, if more than one beam mapping pattern satisfy the predefined criteria, the UE may be pre-defined/configured to select a default pattern to use among the patterns that satisfy the condition. For instance, if the patterns are indexed, the default pattern may be configured to be the pattern with the lower/larger index.

According to an embodiment, the method comprises obtaining, by the user equipment, an indication from the network element to activate or deactivate the mapping of the at least two beams for PUSCH repetition operation. Thus, the network may control the above method and/or any embodiments related thereto by sending an indication or a control signalling for activating or deactivating the operation.

According to an embodiment, the method comprises obtaining, by the user equipment, an indication from the network element to use a specific beam mapping pattern. Accordingly, the network may also dynamically override the beam mapping pattern selected by the UE by indicating, for example via DCI or MAC CE, the beam mapping pattern to be used, in which case the UE should follow this indication.

It is noted that the method is applicable for PUSCH repetition Type A and PUSCH repetition Type B. It is further noted that the method is applicable for both dynamic-grant (DG) PUSCH and configured-grant (CG) PUSCH.

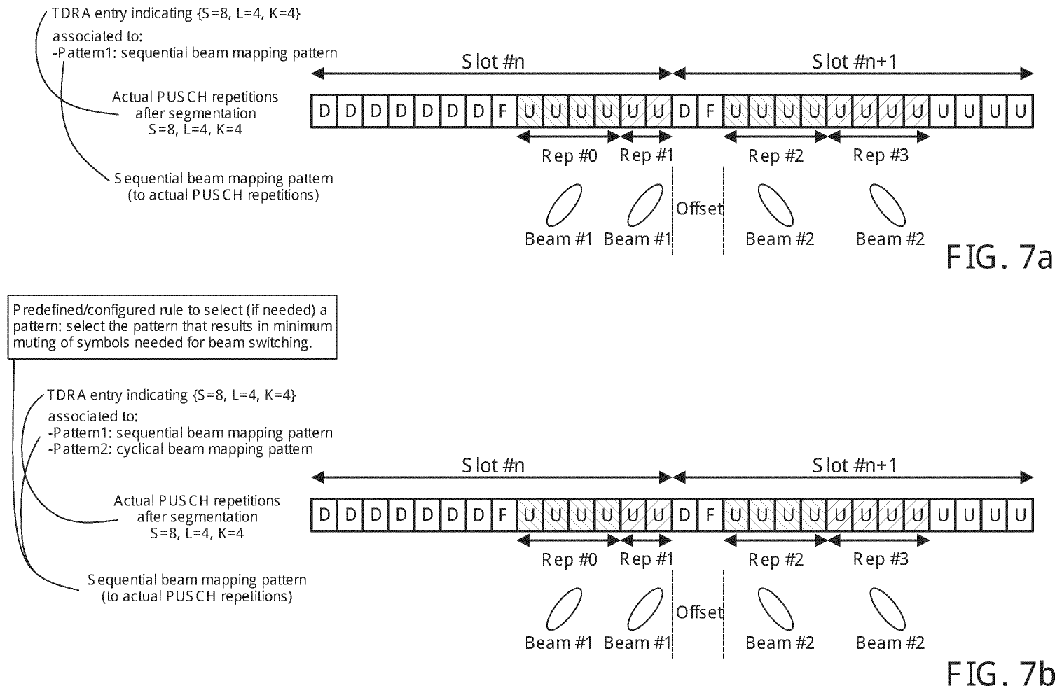

The method and at least some of the embodiments is illustrated in the signalling chart of FIG. 6. The method starts by the network sending the first configuration (600) to the UE, wherein the first configuration comprises multiple beam mapping patterns for mapping at least two beams to at least two PUSCH repetitions, wherein one or more beam mapping patterns are associated with e.g. one TDRA entry. Next, the network may send the second configuration (602) to the UE comprising predefined criteria for selecting among the multiple beam mapping patterns associated with an indicated TDRA entry. It is noted that the UE may already have the predefined criteria previously stored in its memory, the second criteria may have already been sent along the first configuration (600). Thus, sending the second configuration (602) is only an optional step. For allocating the resources for the PUSCH repetition operation, the network indicates one TDRA entry (604) to be used, for example along configured grant (CG) or dynamic grant (DG) procedure. The UE checks whether one or more beam mapping patterns are associated with the indicated TDRA entry. If only one beam mapping pattern is associated with the indicated TDRA entry, the UE determines to use (606) said one beam mapping pattern for the PUSCH repetition operation. If there are multiple beam mapping patterns associated with the indicated TDRA entry, the UE uses (608) the predefined criteria to select one beam mapping pattern for the PUSCH repetition operation. The UE then starts (610) the PUSCH repetition operation by mapping the PUSCH repetitions to the at least two beams according to the selected beam mapping pattern.

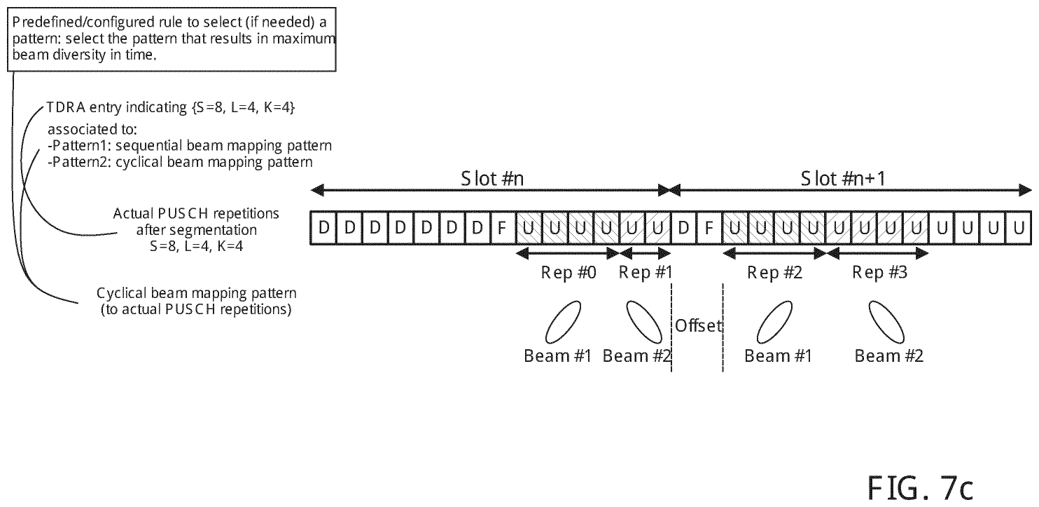

FIGS. 7a-7c illustrate some examples of selecting beam mapping patterns according to the embodiments. In FIG. 7a, the UE is instructed to perform PUSCH Type B repetition with UL beam diversity. Specifically, the indicated TDRA entry corresponds to: S=8 (starting symbol), L=4 (length of each nominal repetition) and K=4 (number of nominal repetitions). After PUSCH segmentation operation, there are 4 actual PUSCH repetitions, Rep #0-Rep #3. In addition, two UL beams are indicated, namely beam #1 and beam #2. It is assumed that the UE needs a delay/offset equivalent to 2 symbols to switch from beam #1 to beam #2.

In the example of FIG. 7a, the indicated TDRA entry is associated to one beam mapping pattern, namely a sequential beam mapping pattern. Hence, when indicated to use this TDRA entry, the UE uses the associated beam mapping pattern to map the indicated beams to the PUSCH repetitions. It is further assumed that the mapping is performed to the actual PUSCH repetitions; i.e. after PUSCH segmentation. Herein, Rep #0 and Rep #1 are mapped to use beam #1,and Rep #2 and Rep #3 are mapped to use beam #2 after the delay/offset of 2 symbols. Alternatively, the mapping of beams may as well be performed to the nominal PUSCH repetitions. It is noted that the first configuration may indicate whether the mapping should be done on nominal PUSCH repetitions, actual PUSCH repetitions, and/or on a slot-basis, etc.

In FIG. 7b, the same TDRA entry parameters and the number of UL beams as in the example of FIG. 7a are used. However, the indicated TDRA entry is associated to two beam mapping patterns, namely a sequential beam mapping pattern and a cyclic beam mapping pattern. In addition, the UE is configured with criteria, either as previously stored in the UE or provided by the network, for selecting a beam mapping pattern when at least two patterns are indicated. In this example, the criteria include a predefined rule instructing to select the pattern that results in minimum muting of symbols needed for beam switching.

Using the indicated TDRA entry, which is associated to two beam mapping patterns, and based on the predefined rule that consists in selecting the pattern that results in minimum muting of symbols needed for beam switching, the UE selects the sequential beam mapping pattern (i.e. Pattern1). The UE then uses this pattern to map the indicated UL beams to the PUSCH repetitions, where it is also assumed that the mapping is done to the actual PUSCH repetitions. As a result, Rep #0 and Rep #1 are mapped to use beam #1, and Rep #2 and Rep #3 are mapped to use beam #2 after the delay/offset of 2 symbols, similarly to the example of FIG. 7a.

In FIG. 7c, the same TDRA entry parameters and the number of UL beams, as well as the association of the indicated TDRA entry to two beam mapping pattern, namely a sequential beam mapping pattern and a cyclic beam mapping pattern, as in the example of FIG. 7b are used. However, in the example of FIG. 7c, the criteria include a predefined rule instructing to select the pattern that results in maximum diversity in time.

Using the indicated TDRA entry, which is associated to two beam mapping patterns, and based on the predefined rule that consists in selecting the pattern that results in maximum diversity in time, the UE selects the cyclic beam mapping pattern (i.e. Pattern2). The UE then uses this pattern to map the indicated UL beams to the PUSCH repetitions, where it is also assumed that the mapping is done to the actual PUSCH repetitions. As a result, Rep #0 is mapped to use beam #1, and for Rep #1, the beam is switched to beam #2. Then again, Rep #2 is mapped to use beam #1 and Rep #3 is switched back to use beam #2. It is noted that no delay/offset when switching between Rep #0 and Rep #1 and Rep #2 and Rep #3, respectively, is shown in FIG. 7c.

An apparatus, such as a UE, according to an aspect comprises means for obtaining a first configuration from a network element, the first configuration comprising multiple beam mapping patterns for mapping at least two beams to at least two PUSCH repetitions, wherein one or more beam mapping patterns are associated with at least one time domain resource assignment option; means for obtaining an indication of a time domain resource assignment for PUSCH repetition operation from the network element; means for checking whether one or more beam mapping patterns are associated with the indicated time domain resource assignment; means, responsive to only one beam mapping pattern being associated with the indicated time domain resource assignment, for using said one beam mapping pattern for mapping said at least two PUSCH repetitions; and means, responsive to multiple beam mapping patterns being associated with the indicated time domain resource assignment, for selecting one beam mapping pattern for mapping said at least two PUSCH repetitions according to a predefined criteria.

An apparatus according to a further aspect comprises at least one processor and at least one memory, said at least one memory stored with computer program code thereon, the at least one memory and the computer program code configured to, with the at least one processor, cause the apparatus at least to perform: obtain a first configuration from a network element, the first configuration comprising multiple beam mapping patterns for mapping at least two beams to at least two Physical Uplink Shared Channel (PUSCH) repetitions, wherein one or more beam mapping patterns are associated with at least one time domain resource assignment option; obtain an indication of a time domain resource assignment for PUSCH repetition operation from the network element; check whether one or more beam mapping patterns are associated with the indicated time domain resource assignment; and if only one beam mapping pattern is associated with the indicated time domain resource assignment, use said one beam mapping pattern for mapping said at least two PUSCH repetitions; or else select, from the multiple beam mapping patterns associated with the indicated time domain resource assignment, one beam mapping pattern for mapping said at least two PUSCH repetitions according to predefined criteria.

Such apparatuses may comprise e.g. the functional units disclosed in any of the FIGS. 1, 2 and 3 for implementing the embodiments.

A further aspect relates to a computer program product, stored on a non-transitory memory medium, comprising computer program code, which when executed by at least one processor, causes an apparatus at least to perform: obtain a first configuration from a network element, the first configuration comprising multiple beam mapping patterns for mapping at least two beams to at least two Physical Uplink Shared Channel (PUSCH) repetitions, wherein one or more beam mapping patterns are associated with at least one time domain resource assignment option; obtain an indication of a time domain resource assignment for PUSCH repetition operation from the network element; check whether one or more beam mapping patterns are associated with the indicated time domain resource assignment; and if only one beam mapping pattern is associated with the indicated time domain resource assignment, use said one beam mapping pattern for mapping said at least two PUSCH repetitions; or else select, from the multiple beam mapping patterns associated with the indicated time domain resource assignment, one beam mapping pattern for mapping said at least two PUSCH repetitions according to predefined criteria.

Another aspect relates to the operation of a base station or an access point, such as a gNB, for configuring a user equipment with multiple beam mapping patterns for mapping at least two beams to a PUSCH repetition operation.

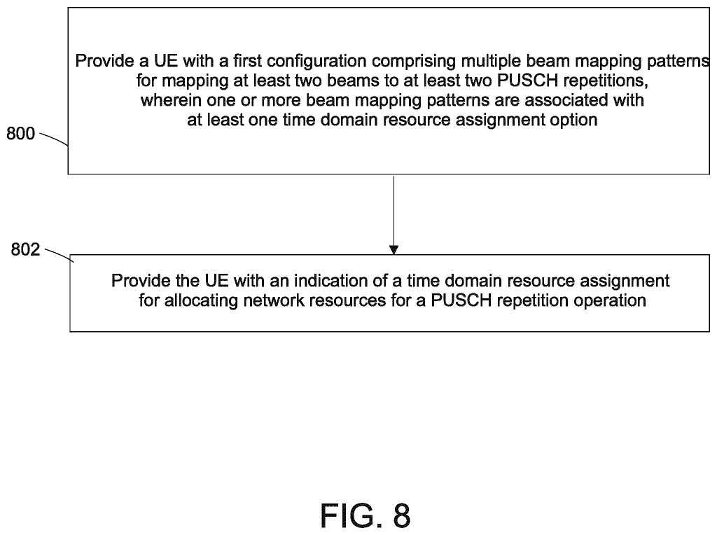

The flow chart of FIG. 8 illustrates a method carried out by a base station, wherein the method comprises providing (800) a user equipment with a first configuration comprising multiple beam mapping patterns for mapping at least two beams to at least two PUSCH repetitions, wherein one or more beam mapping patterns are associated with at least one time domain resource assignment option; and providing (802) the user equipment with an indication of a time domain resource assignment for allocating network resources for a PUSCH repetition operation.

Hence, the network may configure a user equipment with multiple beam mapping patterns for mapping at least two beams to a PUSCH repetition operation in a situation, where the PUSCH repetition transmission is to be implemented in multi-TRP and/or multi-panel transmission. Thus, depending on the actual situation, where the PUSCH repetition operation takes place, the UE has information for selecting an appropriate beam mapping pattern so that, for example, beam switching latency aspects are addressed in more optimal manner.

According to an embodiment, the method comprises providing the user equipment with a second configuration comprising predefined criteria for selecting among the multiple beam mapping patterns associated with the indicated time domain resource assignment.

Hence, the network may provide the user equipment with predefined criteria for selecting the appropriate beam mapping pattern among the multiple beam mapping patterns, for example, such that beam switching latency aspects are addressed in a most optimal manner for the current network resources.

The method and the embodiments related thereto may be implemented in an apparatus implementing an access point or a base station of a radio access network, such as an eNB or a gNB. The apparatus may comprise at least one processor and at least one memory, said at least one memory stored with computer program code thereon, the at least one memory and the computer program code configured to, with the at least one processor, cause the apparatus at least to perform: provide a user equipment with a first configuration comprising multiple beam mapping patterns for mapping at least two beams to at least two PUSCH repetitions, wherein one or more beam mapping patterns are associated with at least one time domain resource assignment option; and provide the user equipment with an indication of a time domain resource assignment for allocating network resources for a PUSCH repetition operation.

Such an apparatus may likewise comprise: means for providing a user equipment with a first configuration comprising multiple beam mapping patterns for mapping at least two beams to at least two PUSCH repetitions, wherein one or more beam mapping patterns are associated with at least one time domain resource assignment option; and means for providing the user equipment with an indication of a time domain resource assignment for allocating network resources for a PUSCH repetition operation.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1-14. (canceled)

15. A method, comprising:
obtaining, with a user equipment, a first configuration from a network element, the first configuration comprising multiple beam mapping patterns for mapping at least two beams to at least two physical uplink shared channel repetitions, wherein one or more beam mapping patterns are associated with at least one time domain resource assignment option;
obtaining an indication of a time domain resource assignment for a physical uplink shared channel repetition operation from the network element;
checking whether one or more beam mapping patterns are associated with the indicated time domain resource assignment; and
if one beam mapping pattern is associated with the indicated time domain resource assignment, using said one beam mapping pattern for mapping said at least two physical uplink shared channel repetitions; or else
selecting, from the multiple beam mapping patterns associated with the indicated time domain resource assignment, one beam mapping pattern for mapping said at least two physical uplink shared channel repetitions according to predefined criteria.

16. The method according to claim 15, wherein the one or more beam mapping patterns are associated as common for said time domain resource assignment options.

17. The method according to claim 15, wherein a different set of one or more beam mapping patterns is associated with said time domain resource assignment options.

18. The method according to claim 15, comprising,
configuring said one or more beam mapping patterns according to one or more of the following parameters:
a type of the mapping pattern; or
a basis for mapping.

19. The method according to claim 15, comprising storing said predefined criteria in a non-transitory memory of the user equipment.

20. The method according to claim 15, comprising obtaining a second configuration from the network element, the second configuration comprising said predefined criteria for selecting among the multiple beam mapping patterns associated with the indicated time domain resource assignment.

21. The method according to claim 15, comprising selecting the type of the mapping pattern that minimizes the number of symbols that need to be muted accounting for at least one beam switching delay.

22. The method according to claim 15, comprising selecting the type of the mapping pattern that maximizes the number of beam switching instances.

23. The method according to claim 15, comprising selecting the type of the mapping pattern that minimizes the number of repetitions towards at least one transmission or reception point.

24. The method according to claim 15, comprising using a starting redundancy version indication per transmission or reception point to determine the type of the mapping pattern.

25. The method according to claim 15, comprising selecting a default type of the mapping pattern among a plurality of patterns satisfying the predefined criteria.

26. The method according to claim 15, comprising obtaining an indication from the network element to activate or deactivate the mapping of the at least two beams for the physical uplink shared channel repetition operation.

27. The method according to claim 15, comprising obtaining an indication from the network element to use a specific beam mapping pattern.

28-30. (canceled)

31. A method, comprising:
providing a user equipment with a first configuration comprising multiple beam mapping patterns for mapping at least two beams to at least two physical uplink shared channel repetitions, wherein one or more beam mapping patterns are associated with at least one time domain resource assignment option; and
providing the user equipment with an indication of a time domain resource assignment for allocating network resources for a physical uplink shared channel repetition operation.

32. The method according to claim 31, comprising providing the user equipment with a second configuration comprising predefined criteria for selecting among the multiple beam mapping patterns associated with the indicated time domain resource assignment.

33. An apparatus, comprising:
at least one processor; and
at least one non-transitory memory storing instructions that, when executed with the at least one processor, cause the apparatus at least to:
obtain a first configuration from a network element, the first configuration comprising multiple beam mapping patterns for mapping at least two beams to at least two physical uplink shared channel repetitions, wherein one or more beam mapping patterns are associated with at least one time domain resource assignment option;
obtain an indication of a time domain resource assignment for a physical uplink shared channel repetition operation from the network element;
check whether one or more beam mapping patterns are associated with the indicated time domain resource assignment; and
if one beam mapping pattern is associated with the indicated time domain resource assignment, use said one beam mapping pattern for mapping said at least two physical uplink shared channel repetitions; or
else select, from the multiple beam mapping patterns associated with the indicated time domain resource assignment, one beam mapping pattern for mapping said at least two physical uplink shared channel repetitions according to predefined criteria.

34. An apparatus, comprising:
at least one processor; and
at least one non-transitory memory storing instructions that, when executed with the at least one processor, cause the apparatus at least to:
provide a user equipment with a first configuration comprising multiple beam mapping patterns for mapping at least two beams to at least two physical uplink shared channel repetitions, wherein one or more beam mapping patterns are associated with at least one time domain resource assignment option; and
provide the user equipment with an indication of a time domain resource assignment for allocating network resources for a physical uplink shared channel repetition operation.

35. The method according to claim 18,
wherein the type of the mapping pattern comprises one or more of sequential mapping, cyclical mapping, or half-to-half mapping; and
wherein the basis for mapping comprises one or more of mapping performed on nominal physical uplink shared channel repetitions, actual physical uplink shared channel repetitions, at least one symbol basis, or a slot-basis.

36. A non-transitory program storage device readable with an apparatus, tangibly embodying a program of instructions executable with the apparatus for performing the method of claim 15.

37. A non-transitory program storage device readable with an apparatus, tangibly embodying a program of instructions executable with the apparatus for performing the method of claim 31.
